(19) United States
(12) Patent Application Publication
(10) Pub. No.: US 2023/0024026 A1
(43) Pub. Date: Jan. 26, 2023

(54) PICKUP CARGO BED STORAGE SYSTEM

(71) Applicant: ABC Technologies Inc., Toronto (CA)

(72) Inventors: Harman GILL, Brampton, ON (CA); Avinash JAYAKUMAR, Mississauga, ON (CA); Usman DULATOV, Newmarket, ON (CA)

(21) Appl. No.: 17/872,246

(22) Filed: Jul. 25, 2022

Related U.S. Application Data
(60) Provisional application No. 63/225,599, filed on Jul. 26, 2021.

(51) Int. Cl. B60R 11/06; B60R 9/06

(52) U.S. Cl. CPC B60R 11/06; B60R 9/06; B60R 2011/004

(57) ABSTRACT

Provided is a storage system for a pickup truck cargo bed. The storage system includes a frame assembly dimensioned to be nested within and fixedly attached to the cargo bed between opposing side wall sections thereof, the frame assembly further being dimensioned to extend the length of the cargo bed. The storage system additionally includes a first drawer configured to be deployable from the frame assembly, and a second drawer configured to be deployable from the frame assembly, the first and second drawers being separately deployable. The frame assembly further includes a load supporting top wall to permit for the transport of goods in the area above the storage system.

### CROSS-REFERENCE TO RELATED APPLICATIONS

This application claims the benefit of U.S. Provisional Patent Application Ser. No. 63/225,599, filed Jul. 26, 2021, which is hereby incorporated by reference in its entirety for all purposes.

### FIELD OF THE INVENTION

The present invention pertains to a storage system for a pickup truck, and in particular to a storage system including drawers and flip-up dividers.

### BACKGROUND

Pickup trucks have functional attributes that permit them to be used for a range of applications. This is evident in the market, as pickup trucks are immensely popular for both recreational and work-related transport. Pickup trucks are now available in a range of configurations, but are generally regarded as providing an enclosed cab, for the driver and passengers, and an open rear cargo bed. Although the cargo bed is bordered by two sidewall sections, and a rear tailgate, the top side of the cargo bed is open, therein presenting certain issues relating to security, privacy and general securement of items contained therein.

To ensure items placed within the cargo area are protected from being stolen and/or vandalized, and to prevent inadvertent loss due to items falling out of the cargo bed during transport, a variety of cargo bed enclosure systems have been proposed. Where an enclosure is provided for a cargo bed, the ability to secure and retain items in defined areas remains of paramount importance, to ensure the user is not challenged with collecting cargo items that have scattered about the cargo area. It is therefore desirable to provide a cargo bed storage system that subdivides the cargo bed into defined cargo storage areas, that permit for organized storage with reduced likelihood of items moving about during transport.

### BRIEF SUMMARY

Embodiments hereof relate to a storage system for a pickup truck cargo bed. The storage system includes a frame assembly dimensioned to be nested within and fixedly attached to the cargo bed between opposing side wall sections thereof, the frame assembly further being dimensioned to extend the length of the cargo bed. The storage system additionally includes a first drawer configured to be deployable from the frame assembly, and a second drawer configured to be deployable from the frame assembly, the first and second drawers being separately deployable. The frame assembly further includes a load supporting top wall to permit for the transport of goods in the area above the storage system.

### BRIEF DESCRIPTION OF THE DRAWINGS

The foregoing and other features and advantages of the invention will be apparent from the following description of embodiments thereof as illustrated in the accompanying drawings. The accompanying drawings, which are incorporated herein and form a part of the specification, further serve to explain the principles of the invention and to enable a person skilled in the pertinent art to make and use the invention. The drawings are not to scale.

FIG. 1 is a perspective view of a pickup truck having a cargo bed.

FIG. 2a is a perspective view of a storage system having two pull out drawers.

FIG. 2b is a perspective view of the storage system of FIG. 2a, with the drawers removed.

FIG. 3a is a perspective view of the storage system of FIG. 2a, with the first drawer in the open position.

FIG. 3b is a perspective view of the storage system of FIG. 2a, with the first drawer in the open position, with the retractable lid in the open position.

FIG. 4a is a perspective view of the storage system of FIG. 2a, with the second drawer in the open position.

FIG. 4b is a perspective view of the storage system of FIG. 2a, with the second drawer in the open position, with the removeable lids removed.

FIG. 5 is a sectional view of the storage system of FIG. 2a, detailing aspects of the slide assembly of the drawers.

FIG. 6 is a perspective view of the storage system of FIG. 2a, showing the dividers in the up position.

### DETAILED DESCRIPTION OF THE INVENTION

The following detailed description is merely exemplary in nature and is not intended to limit the disclosure or the application and uses of the disclosure. A person skilled in the relevant art will recognize that other configurations and arrangements can be used without departing from the scope of the disclosure. Furthermore, there is no intention to be bound by any expressed or implied theory presented in the preceding technical field, background, brief summary, or the following detailed description.

It should be noted that in the description, terms such as forward, front and derivations of these terms are intended to mean or refer to an orientation directed towards, or a location situated towards, the front of the vehicle or component in question relative to its orientation within a vehicle. Similarly, terms such as rearward, rear and derivations of these terms are intended to mean or refer to an orientation directed towards, or a location situated towards, the back of the vehicle or component in question relative to its orientation within a vehicle. Terms such as up, upper, upward, and derivations of these terms are intended to mean or refer to an orientation that is above or on a top side of the vehicle or component in question relative to its orientation within a vehicle. Terms such as lower, down, downward, and derivations of these terms are intended to mean or refer to an orientation that is below or on a bottom side of the vehicle or component in question relative to its orientation within a vehicle. The term outer, outboard, outside and derivations of these terms is intended to mean or refer to an orientation directed towards, or a location situated outwardly from the side of the vehicle or component in question relative to its orientation within a vehicle. The term inner, inboard, inside and derivations of these terms is intended to mean or refer to an orientation directed towards, or a location situated towards a longitudinal centerline of the vehicle, or component in question relative to its orientation within a vehicle.

In addition, the terms “preferred,” “preferably,” or “in particular,” “for example” or similar terms are used in association with optional features without thereby restricting alternative embodiments. Thus, features which are introduced by these terms are optional features, and there is no intention to restrict the scope of protection of the claims and, in particular, the independent claims by means of these features. Thus, as a person skilled in the art will recognize, the invention can also be implemented using different embodiments. In a similar way, features which are introduced by “in one embodiment of the invention” or by “in one illustrative embodiment of the invention” are understood to be optional features without any intention thereby to restrict alternative embodiments or the scope of protection of the independent claims. Moreover, these introductory expressions are not intended to affect all the ways of combining the features introduced thereby with other features, whether optional or non-optional features.

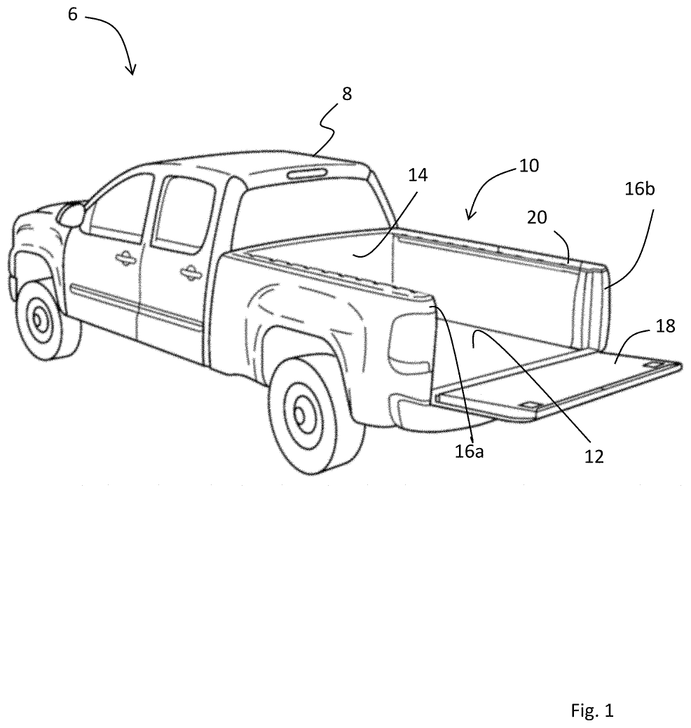

Referring now to FIG. 1, shown is a vehicle or pickup truck 6 having a cab 8 and a cargo bed 10 situated rearward therefrom. The cargo bed 10 includes a floor 12, an upstanding forward wall 14 immediately adjacent and rearward of the cab 8, and two upstanding opposing sidewall sections 16a, 16b. Opposite to the forward wall 14 towards the rear of the cargo bed 10 is situated a tailgate 18. The tailgate 18 is provided with a hinge assembly (not shown) permitting the tailgate 18 to pivot from a generally vertical/upright closed position, to a generally horizontal open position as required by the operator. As shown in FIG. 1, the tailgate 18 is in the open position. The forward wall 14 and the two opposing sidewall sections 16a, 16b define an upper wall surface that is generally planar. The upper wall surface is collectively regarded as the bed rail 20.

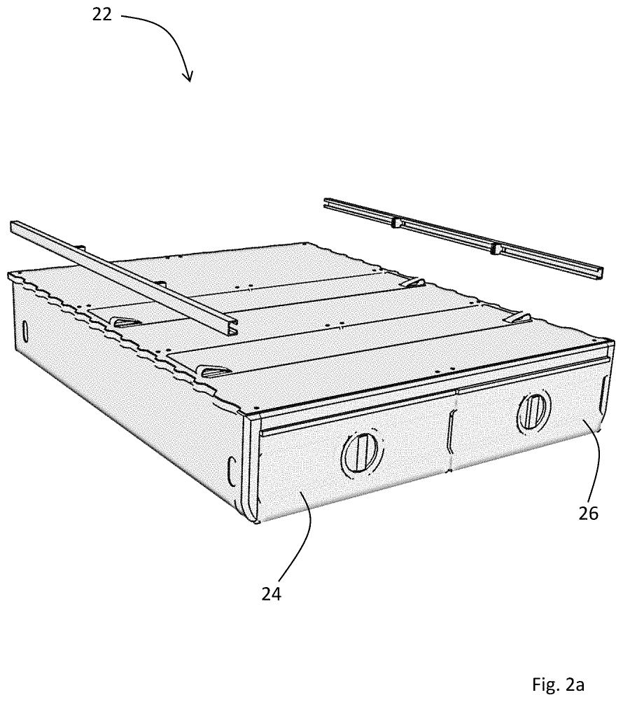

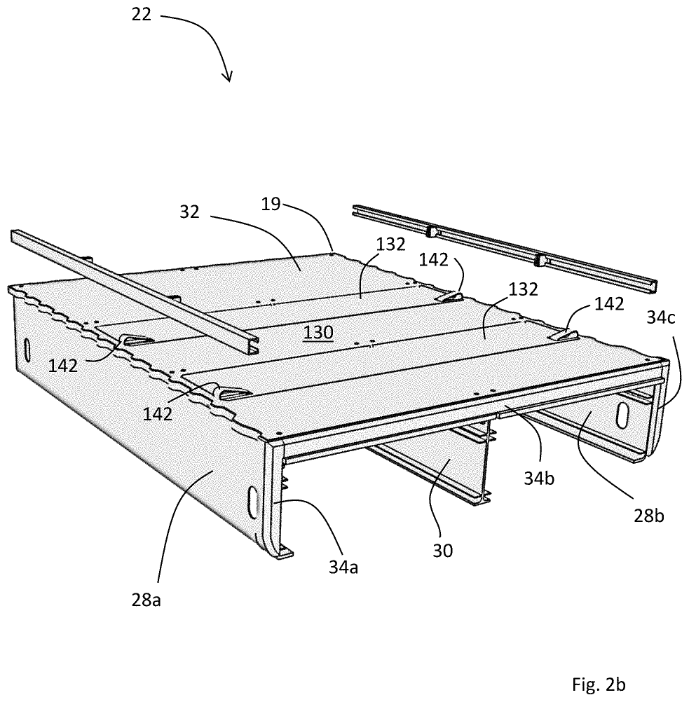

Referring now to FIG. 2a, shown in isolation is a storage system 22 for use in the cargo bed 10 of the pickup truck 6. The storage system 22 is nested within and fixedly attached to the cargo bed 10 in a manner that secures it between the opposing sidewall sections 16a, 16b. The storage system 22 is also shown to be dimensioned such that it extends the length of the cargo bed 10, that is from the forward wall 14 rearwardly to the tailgate 18. The storage system 22 includes a frame assembly 19, a first drawer 24 and a second drawer 26, the first and second drawers 24, 26 being separately deployable from the frame assembly 19 to permit for organized cargo stowage within the storage system 22.

With reference to FIG. 2b, the storage system 22 is shown with the first and second drawers 24, 26 removed, to detail aspects of its construction. The frame assembly 19 of the storage system 22 includes a first side wall 28a, a second side wall 28b, and a central support wall 30. Also provided is a load-supporting top wall 32, and framing elements 34a, 34b, 34c to provide an aesthetically pleasing appearance to the functional (opening) end of the storage system 22.

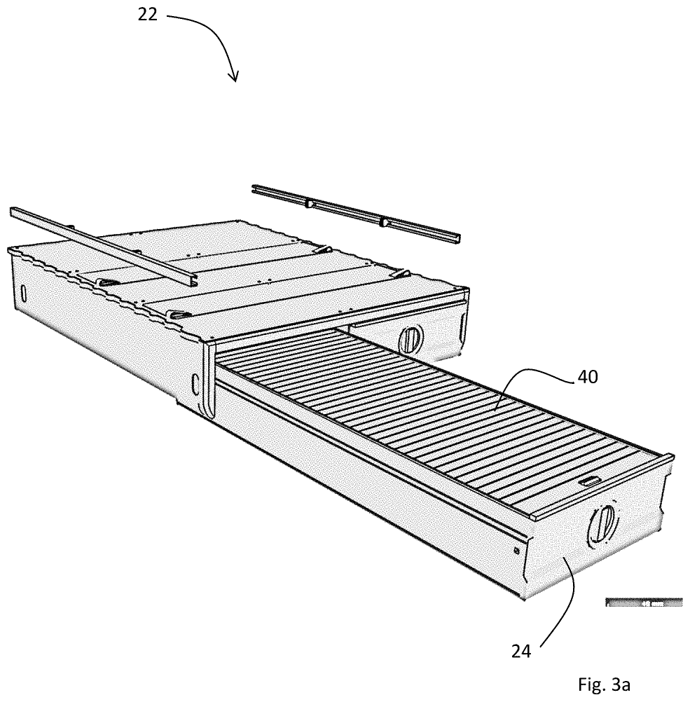

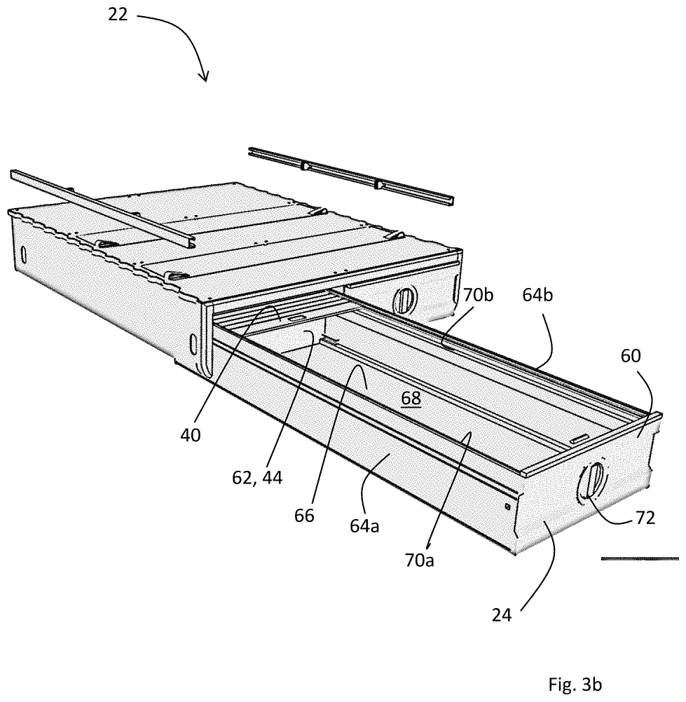

With reference now to FIGS. 3a and 3b, the storage system 22 is shown with the first drawer 24 in the fully extended (outward) position. The first drawer 24 is shown in FIG. 3a with a tambour door retractable lid 40 in the fully closed position, while FIG. 3b shows the first drawer 24 with the retractable lid 40 in the fully open position. Continuing with FIG. 3b, the first drawer is shown to include a forward panel 60, a rearward panel 62, opposing side panels 64a, 64b (collectively 64), and a floor panel 66. The various drawer panels 60, 62, 64, 66 are assembled to define a first cargo compartment 68 suitable for stowage of cargo items within the storage system 22. As the first drawer 24 includes the tambour door for the retractable lid 40, the rearward panel 62 may in fact be the rearward wall of a tambour door roller unit 44, which receives the door when opened. The first drawer is also shown to include a first channel 70a on the first side panel 64a and a second channel 70b on the second side panel 64b, the first and second channels serving to guide the retractable lid 40 through its range of motion between the fully open position and the fully closed position. To provide additional security to the cargo contained within the first drawer 24, a drawer lock 72 may be provided on the forward panel 60.

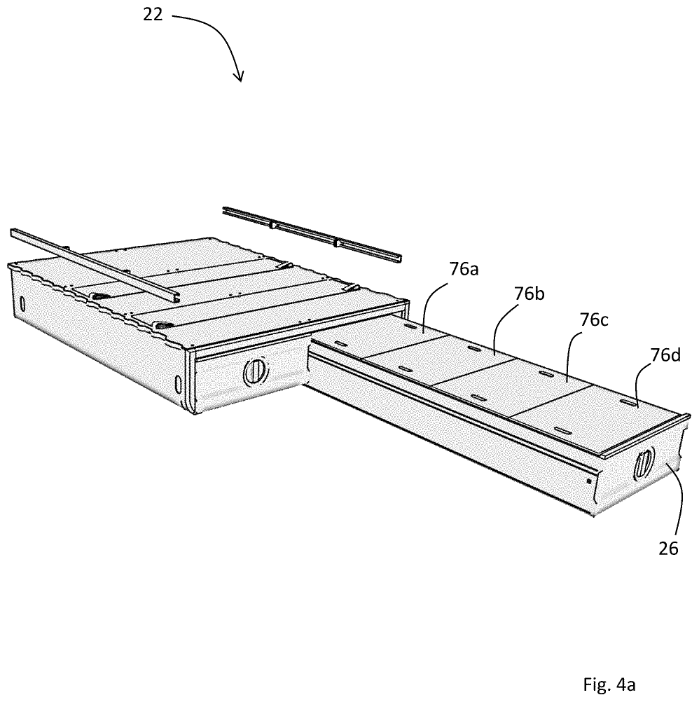

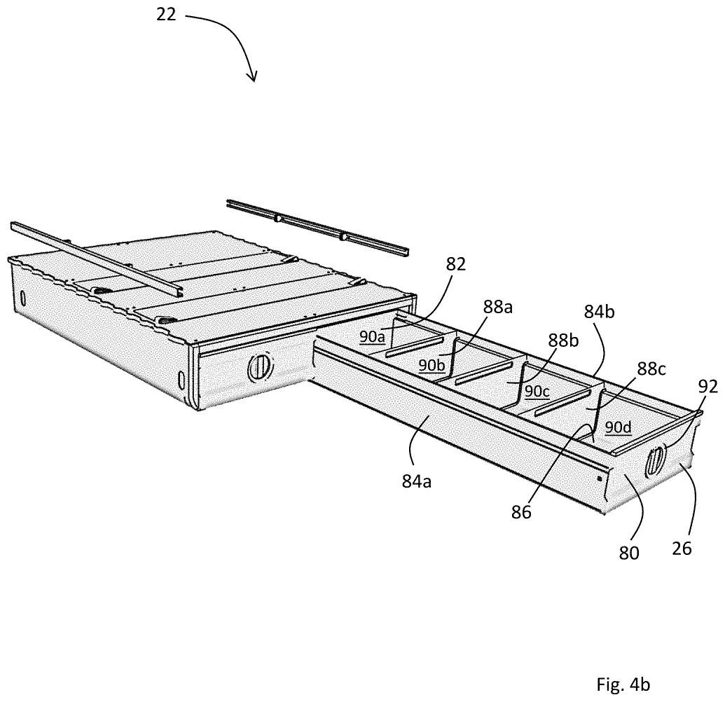

With reference now to FIGS. 4a and 4b, the storage system 22 is shown with the second drawer 26 in the fully extended (outward) position. The second drawer 26 is shown in FIG. 4a with a series of removeable lids 76a, 76b, 76c, 76d in position to collectively close the second drawer 26, while FIG. 4b shows the second drawer 26 with the removeable lids 76a, 76b, 76c, 76d removed. Continuing with FIG. 4b, the second drawer is shown to include a forward panel 80, a rearward panel 82, opposing side panels 84a, 84b (collectively 84), and a floor panel 86. The second drawer 26 is also shown to include a first divider panel 88a, a second divider panel 88b, and a third divider panel 88c to effectively divide the interior area of the second drawer 26 into a plurality of cargo compartments. As shown, the second drawer 26, and therein the storage system 22 includes a second cargo compartment 90a, a third cargo compartment 90b, a fourth cargo compartment 90c, and a fifth cargo compartment 90d, each of the cargo compartments 90a, 90b, 90c, 90d being closed by a respective removeable lid 76a, 76b, 76c, 76d. To provide additional security to the cargo contained within the second drawer 26, a drawer lock 92 may be provided on the forward panel 80.

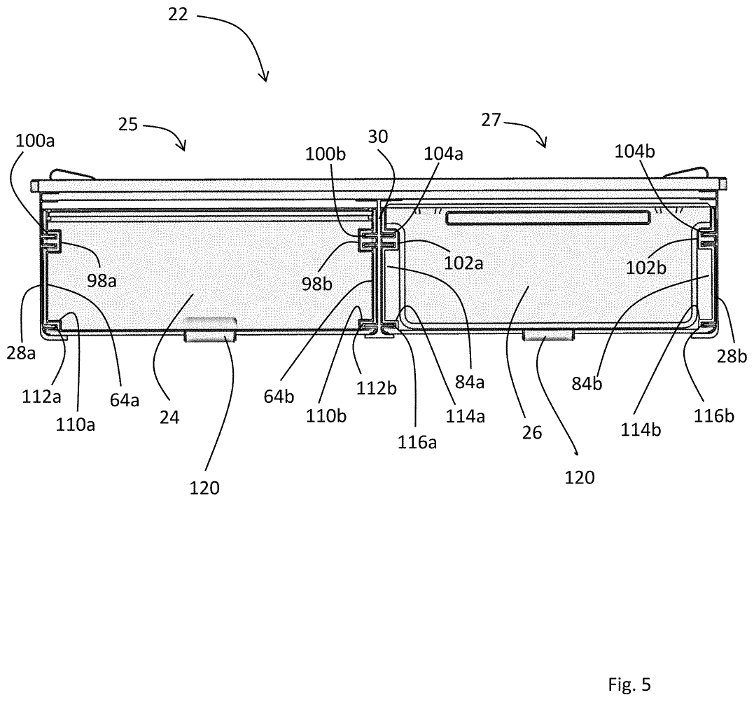

With reference now to FIG. 5, a sectional view of the storage system 22 is shown, to detail aspects of the drawer slide assembly. While a variety of drawer slide assemblies may be implemented to achieve the desired functionality, in the embodiment shown the drawer slides are configured as a runner/channel system. More specifically, with reference to the first drawer 24, a first slide assembly 25 includes on each of the opposing side panels 64a, 64b a respective drawer channel 98a, 98b that cooperates with a respective drawer runner 100a, 100b, the first drawer runner 100a being provided on the first side wall 28a, and the second drawer runner 100b being provided on the central support wall 30. The second slide assembly 27 of the second drawer 26 is similarly configured, where each of the opposing side panels 84a, 84b includes a respective drawer channel 102a, 102b that cooperate with a respective drawer runner 104a, 104b, the first drawer runner 104a being provided on the central support wall 30, and the second drawer runner 104b being provided on the second side wall 28b.

The drawer slide assembly may additionally include lower slide supports on one or both of the first and second drawers 24, 26. As shown, each of the first and second drawers 24, 26 include lower slide supports. More specifically, with reference to the first drawer 24, each of the opposing side panels 64a, 64b includes a respective lower drawer shoulder 110a, 110b that cooperates with a respective lower drawer runner 112a, 112b, the first drawer runner 112a being provided on the first side wall 28a, and the second drawer runner 112b being provided on the central support wall 30. The slide assembly of the second drawer 26 is similarly configured, where each of the opposing side panels 84a, 84b includes a respective lower drawer shoulder 114a, 114b that cooperate with a respective lower drawer runner 116a, 116b, the first drawer runner 116a being provided on the central support wall 30, and the second drawer runner 116b being provided on the second side wall 28b.

To facilitate the opening/closing of the drawers, one or both of the first and second drawers 24, 26 may include one or more rollers provided on an underside surface thereof. In the embodiment shown, each of the first and second drawers 24, 26 includes two rollers 120, arranged generally along the longitudinal centerline of each respective drawer.

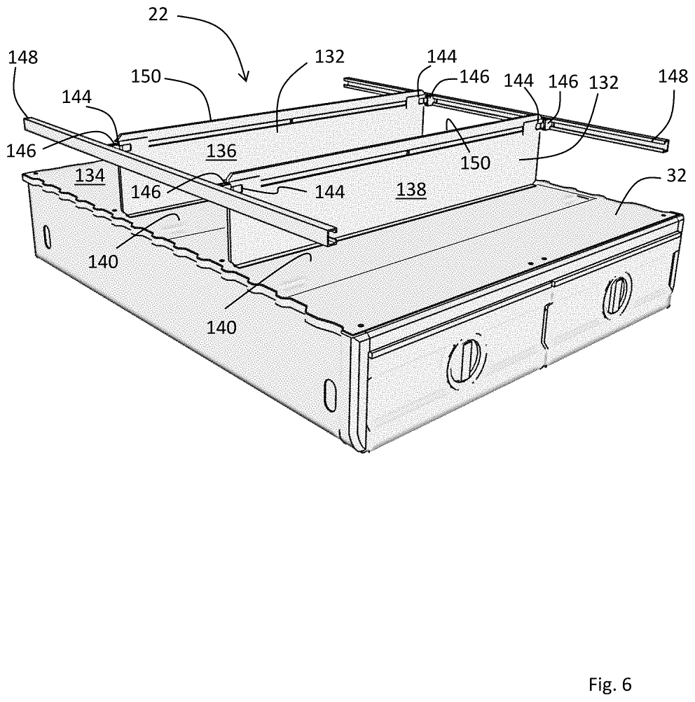

With reference again to FIG. 2b, the storage system 22 is shown in a first configuration where the load-supporting top wall 32 includes a planar surface, suitable for transporting items such as sheet goods (i.e., plywood panels). As such, it can be said that the storage system 22 defines a sixth cargo compartment 130, in the area of the cargo bed 10 above the top wall 32 of the storage system 22. In instances where it is preferred that this area is subdivided to provide better containment of cargo items being stowed/transported, the top wall 32 includes one or more flip up dividers 132. In the embodiment shown in FIG. 6, the storage system 22 is shown with two dividers 132 in the upright position, therein converting the sixth cargo compartment into a seventh cargo compartment 134, an eight cargo compartment 136 and a ninth cargo compartment 138. The dividers 132 are operably connected to the top wall 32 using suitable hinges (not shown), and may seat within corresponding recesses 140 in the top wall 32 when in the down position (as shown in FIG. 2a). Each divider 132 is provided with handles 142 that facilitate lifting the divider from the recess 140 into the upright position.

To maintain the dividers 132 in the upright position, each side of the dividers 132 is provided with a latch mechanism 144 that permits the dividers to releasably lock into receivers 146 provided on a utility rail 148 attached along each of the sidewall sections 16a, 16b, generally at or slightly below the bed rail 20. The dividers 132 are dimensioned such that when in the upright position, an upper topside edge 150 generally aligns to the upper wall surface of the bed rail 20. In this way, the dividers 132 may be used in cooperation with a tonneau cover to fully enclose the cargo compartments formed by the dividers. It will be appreciated that the manner by which the dividers 132 are maintained in the upright position may be achieved in a number of ways. For example, the dividers may incorporate a lockable hinge mechanism that locks the dividers into the desired position.

The storage system, and in particular the components that establish the overall structural elements of the assembly, may be manufactured from any suitable material including, but not limited to plastics. Suitable plastics may include, but are not limited to

1. Polypropylene (PP)—(glass-filled, or carbon-fiber filled)

2. Nylon/Polyamide (PA) (11, 12, 6, 66)—(glass-filled, or carbon-fiber filled)

3. High-density polyethylene (HDPE)

4. Acrylonitrile butadiene styrene (ABS)

5. Acrylonitrile butadiene styrene/polycarbonate (ABS-PC)

6. ethylene propylene diene monomer (EPDM)

7. polypropylene—ethylene propylene diene monomer (PP-EPDM)

8. TPE (thermoplastic Elastomers)

The use of plastics may be further enhanced through the use of fillers, including but not limited to natural fibers, glass fiber, virgin and/or recycled carbon fiber, colours/dyes, as well as fillers that confer UV resistance and/or chemical resistance. It will be appreciated that the storage system may be manufactured from a combination of materials. Contact surfaces that are intended to grip and retain cargo may be provided with rubber or rubber-like materials to prevent slipping or dislodgement during use.

While various embodiments according to the present invention have been described above, it should be understood that they have been presented by way of illustration and example only, and not limitation. It will be apparent to persons skilled in the relevant art that various changes in form and detail can be made therein without departing from the scope of the invention. Thus, the breadth and scope of the present invention should not be limited by any of the above-described exemplary embodiments but should be defined only in accordance with the appended claims and their equivalents. It will also be understood that each feature of each embodiment discussed herein, and of each reference cited herein, can be used in combination with the features of any other combination. All patents and publications discussed herein are incorporated by reference herein in their entirety.

What is claimed is:

1. A storage system for a pickup truck cargo bed, the storage system comprising:
a frame assembly dimensioned to be nested within and fixedly attached to the cargo bed between opposing side wall sections thereof, the frame assembly further being dimensioned to extend the length of the cargo bed;
a first drawer configured to be deployable from the frame assembly; and
a second drawer configured to be deployable from the frame assembly;
wherein the first and second drawers are separately deployable, and
wherein the frame assembly further includes a load supporting top wall to permit for the transport of goods in the area above the storage system.

2. The storage system according to claim 1, wherein the frame assembly includes a first side wall, a second side wall, and a central support wall.

3. The storage system according to claim 2, wherein the frame assembly provides a first slide assembly to permit the first drawer to be slidingly deployed from between the first side wall and the central support wall, and a second slide assembly to permit the second drawer to be slidingly deployed from between the central support wall and the second side wall.

4. The storage system according to claim 3, wherein each of the first and second slide assemblies are configured as a runner and channel system, with the channels being provided on opposing side panels of each drawer, and the cooperating runners being provided on the respective side wall and central support wall of the frame assembly.

5. The storage system according to claim 1, wherein at least one of the first and second drawers includes one or more rollers on an underside thereof, to facilitate the opening/closing of the drawers.

6. The storage system according to claim 1, wherein at least one of the first and second drawers is provided with a tambour-style retractable lid.

7. The storage system according to claim 1, wherein at least one of the first and second drawers is provided with one or more separately removeable lids, and wherein each removeable lid covers a separate storage compartment delineated by corresponding divider panels.

8. The storage system according to claim 1, wherein the load supporting top wall includes at least one flip-up divider.

9. The storage system according to claim 8, wherein the at least one flip-up divider is operably connected to the load supporting top wall using suitable hinges.

10. The storage system according to claim 8, wherein the at least one flip-up divider is configured to seat within a corresponding recess provided in the load supporting top wall.

11. The storage system according to claim 8, wherein the at least one flip-up divider is provided with a latch mechanism that permits the dividers to releasably lock into receivers provided on a utility rail attached along each side wall section of the cargo bed.

12. The storage system according to claim 8, wherein the at least one flip-up dividers is dimensioned such that when in the upright position, an upper topside edge generally aligns to an upper wall surface of the cargo bed.
